(19) United States
(12) Patent Application Publication
(10) Pub. No.: US 2008/0037440 A1
(43) Pub. Date: Feb. 14, 2008

(54) Detecting voice over internet protocol traffic

(76) Inventor: Timothy J. Politowicz, Great Meadows, NJ (US)

Correspondence Address: CARLSON, GASKEY & OLDS, P.C., 400 W MAPLE RD, SUITE 350, BIRMINGHAM, MI, 48009, US

(21) Appl. No.: 11/477,710

(22) Filed: Jun. 29, 2006

(51) Int. Cl. H04L 12/26

(52) U.S. Cl. 370/253

(57) ABSTRACT

A method of detecting voice over Internet protocol (VoIP) traffic utilizes filtering criteria based on assumed packet header information. In a disclosed example, a combination of filtering criteria is based upon an assumption that VoIP traffic will be transported using the Real time Transport Protocol (RTP). In one example, if a correct RTP version is being used and a CSRC count is as expected, a packet is determined to be VoIP traffic. In another example, when a UDP header indicates a payload length within a specified range, UDP ports are both even-numbered, the RTP version is correct and the CSRC count is correct, a packet is determined to be VoIP traffic.

### GOVERNMENT CONTRACT

This invention was made with Government support under Contract MDA904-03-C-0444. The Government has certain rights in this invention.

### FIELD OF THE INVENTION

This invention generally relates to communication. More particularly, this invention relates to Voice over Internet Protocol communications.

### DESCRIPTION OF RELATED ART

Both wired and wireless communications are well known and in widespread use. Traditionally, both have been used for voice communications; for example, in the wireless realm cellular networking technology was optimized to transmit voice traffic. More recently, different types of communications have become available which focus on providing generic data communications; where the data can be anything from an e-mail to encoded voice communications. One such type of communication is referred to as Voice over Internet Protocol (VoIP). Communications using VoIP techniques open up new possibilities for both wired and wireless communications.

VoIP traffic, however, can impact network performance, traffic management and anomaly detection. Further, VoIP traffic has several characteristics that complicate network traffic measurement such as dynamic port negotiation. It is useful to be able to detect VoIP traffic to address such issues.

Detecting VoIP traffic can be difficult, rendering measurement of such traffic difficult. Current techniques for detecting VoIP traffic rely on well known port numbers and maintaining session level information. Commercially available firewall and IDS products, for example, operate by analyzing VoIP control messages to extract negotiated port numbers and then use this communications state information to appropriately handle the voice channel(s).

Maintaining session or flow level information and relying on well known port numbers is not desirable for recognizing VoIP traffic. Moreover, much VoIP traffic uses connections that come up and down so it is not an easy task to track such connections. Even identifying ephemeral ports and watching them as has been proposed does not provide a satisfactory solution.

There is a need for a generic, high speed, single pass type approach for detecting VoIP traffic. This invention addresses that need.

### SUMMARY OF THE INVENTION

An exemplary method of includes determining if a packet includes a header that corresponds to a Real-time Transport Protocol (RTP) header. The packet is determined to correspond to Voice over Internet Protocol (VoIP) traffic if at least two conditions are met. In one example, the two conditions are that the RTP version corresponds to a specified version and that the contributing source count (CSRC) is a specified value.

In one example, the specified RTP version is version 2. In one example whenever the CSRC count is 0, that satisfies the criteria for determining-that a packet is VoIP traffic.

Another example includes utilizing the recognition that most VoIP traffic will be using RTP over the User Datagram Protocol (UDP). In this example, a packet is determined to be VoIP traffic if the UDP header indicates a payload length within a specified range, both UDP ports are even-numbered, the RTP version is the correct number and the CSRC count is correct.

Another example includes utilizing the commonly used values corresponding to audio codecs. In this example, the audio codec value provides increased confidence that it is audio or voice VoIP traffic.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 is a flowchart diagram summarizing one example approach designed according to an embodiment of this invention.

FIG. 2 schematically illustrates an example packet configuration showing various fields in a packet header.

FIG. 3 is a flowchart diagram summarizing another example technique useful with an embodiment of this invention.

### DETAILED DESCRIPTION

Using the techniques described below allows for detecting voice over Internet protocol (VoIP) traffic in a high-speed, sampling indifferent fashion that is independent of the set of interconnections used for the VoIP traffic. The disclosed example approaches are packet-based and take advantage of static values and well-defined protocol headers for filtering out VoIP traffic from other traffic.

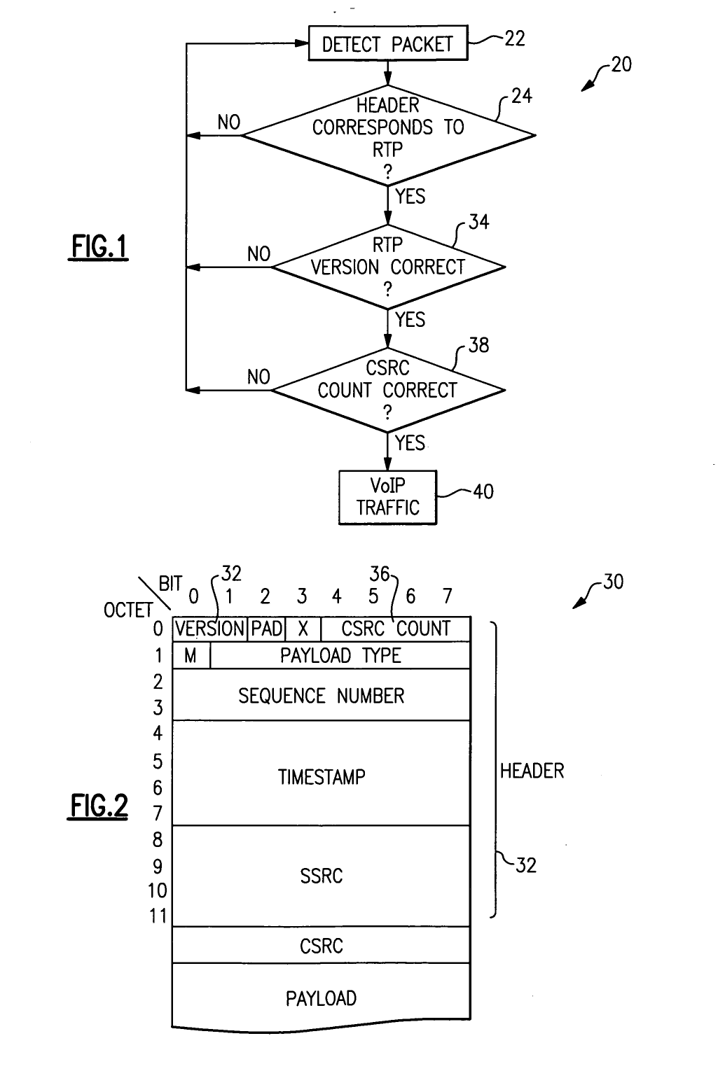

FIG. 1 includes a flowchart diagram 20 that summarizes one example approach. A packet is detected at 22 using a known technique. At 24, a decision is made whether the header of the packet corresponds to a Real-time Transport Protocol (RTP). If not, this packet will not be further considered as potentially VoIP traffic. If the packet is transmitted using RTP, the process in FIG. 1 continues.

One advantage to one example is that the process of analyzing the packet header described below can be initiated without knowing for certain that the header is actually an RTP header. The header can be analyzed without making an up-front determination that it is an RTP header. One example includes assuming that it is and using the disclosed techniques to analyze at least selected header information.

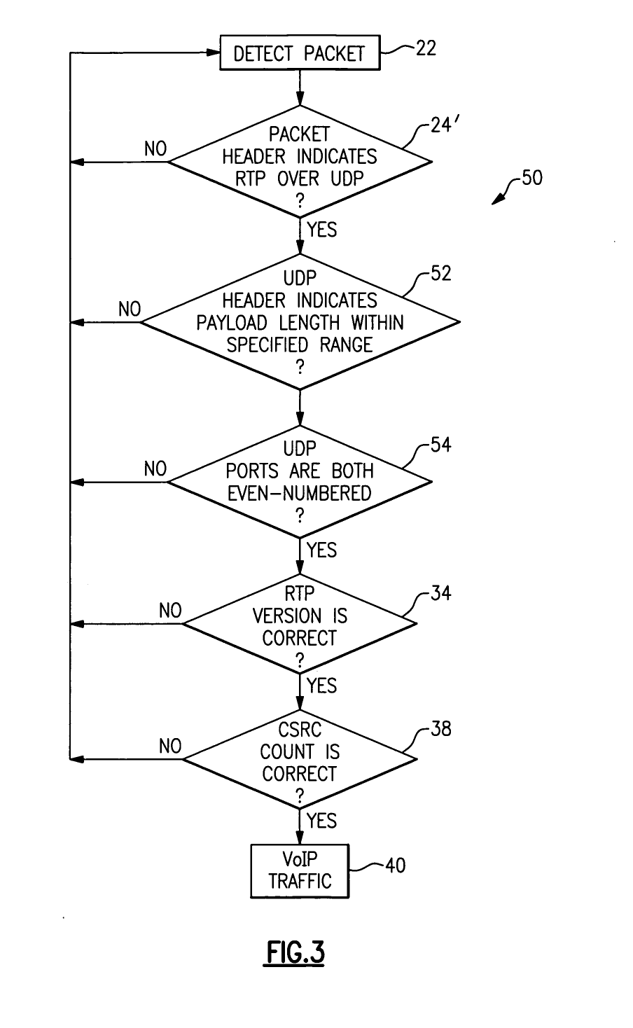

Referring to FIG. 2, an example packet is schematically shown at 30. A header portion 32 includes a plurality of fields that are populated in a known manner. A first portion 32 indicates what version of RTP that is being used for this particular packet. There are at least two known versions of RTP. Version 1 had been used primarily for prototype purposes. Version 2 is known to be used for VoIP traffic, for example.

In FIG. 1, at 34, a decision is made whether the version field 32 indicates the correct RTP version to correspond to VoIP traffic. In one example, when the version is RTP 2, that packet is considered still a potential candidate as VoIP traffic and the process continues as schematically shown in FIG. 1. If the RTP version is not correct, the next packet will be detected at 22.

As shown in FIG. 2, another field 36 of the header 32 contains information regarding a contributing source (CSRC) count. In FIG. 1, a decision is made at 38 whether the CSRC count is the correct value to correspond to VoIP traffic. In one example, this field includes four bits and is required to correspond to a zero value for VoIP traffic. The example field 36 is used to indicate how many contributing source identifiers, if any, are specified in the remainder of the RTP header 32. An audio mixer, for example, inserts the list of contributing source identifiers that were used to create the packet. In this example, requiring the field 36 (e.g., the CSRC count field) to be zero, this provides an identifying characteristic of most VoIP packets as they typically are not mixed. Even if VoIP packets have been mixed, they typically are not specified as such.

As schematically shown at 40 in FIG. 1, a decision is made that a packet is VoIP traffic if all of the conditions in the flowchart 20 have been met.

In this example, the primary assumption is that VoIP traffic will be transported using RTP. Considering the RTP requirements collectively in the described manner specifies a six bit value (0×20) that will eliminate most packets, assuming the values under consideration are random. In other words, there is a very low false positive rate of identifying a detected packet as VoIP traffic when applying the criteria of the previous example.

Another example approach is schematically shown in FIG. 3. In this example, one assumption is that a packet will be transported using the User Datagram Protocol (UDP) and RTP. It is known how to use RTP over UDP for example. In the case of FIG. 3, a flowchart 50 includes the step 22 for detecting the packet. A step 24′ includes analyzing the packet header to determine whether the packet is being transported using RTP over UDP. If not, the next packet will be detected at 22. If so, a decision is made at 52 regarding information within the UDP header. In this example, a determination is made whether the UDP header indicates a payload length within a specified range.

In one example, the determination made at 52 includes determining whether a payload length lₚ satisfies the following relationship l_{RTP}_{_{—}}_{fixed}<lₚ<lₚₘₐₓ; where the values of l_{RTP}_{_{—}}_{fixed} and lₚₘₐₓ are based on analysis. Given this description, those skilled in the art will be able to determine appropriate values. The UDP payload length in this example is specified by a 16 bit header value. The lower bound, l_{RTP}_{_{—}}_{fixed} is based on a minimum, common RTP header size. In this example, the upper bound, lₚₘₐₓ, is based on empirical data. In one example, using these bounds and assuming a typical UDP payload length of 512 bits and a uniform distribution for payload length, the payload constraint (e.g., the filtering decision made at 52) will eliminate a large percentage of UDP packets.

Assuming that the payload length is within the specified range, a decision is made at 54 whether both UDP ports are even-numbered. This filtering requirement in some examples can independently eliminate a significant percentage of UDP packets that do not contain VoIP traffic.

The process of FIG. 3 then continues to make the decisions at 30, which are the same filtering criteria used in the example of FIG. 1. If all of the conditions of FIG. 3 are met, the decision is made that the detected packet is VoIP traffic at 40.

Using the combination of filtering criteria schematically shown in FIG. 3 by combining the UDP header criteria with the RTP header criteria in some examples can provide a very high certainty that VoIP traffic will be properly identified.

One example includes determining audio codec values as a further check on whether a packet is voice or audio VoIP traffic. There are known values and assigned schemes for encoding audio or voice content. Using a check for these provides an additional measure of confidence regarding the determination if a packet is VoIP.

The above examples take advantage of RTP features and the widespread use of RTP for VoIP traffic. Typically, even-numbered ports are used for RTP data transfer and a contiguous odd-numbered port is used for RTP control information. The RTP data stream typically consists of many small, frequently fixed sized packets. For a given VoIP session, the vast majority of packets are RTP. The above-described filtering criteria and the combination of them as used in the disclosed examples provides an effective means of identifying VoIP traffic.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method comprising:
determining if a packet includes a header that corresponds to a Real time Transport Protocol (RTP) header; and
determining that the packet corresponds to voice over Internet protocol traffic if
the packet header indicates a specified RTP version; and
a contributing source count in the packet header is a specified value.

2. The method of claim 1, wherein the RTP version is 2.

3. The method of claim 1, wherein the contributing source count is 0.

4. The method of claim 1, comprising
determining if the packet includes a header that corresponds to a user data-gram protocol (UDP).

5. The method of claim 4, comprising
determining if the UDP header indicates a payload length within a specified range.

6. The method of claim 4, comprising
determining if the UDP header indicates two UDP ports that are even-numbered.

7. The method of claim 1, comprising determining whether a codec value of the packet corresponds to voice or audio.

8. A method comprising:
determining if a packet includes a header that corresponds to a user data-gram protocol (UDP) and a real time transport protocol (RTP); and
determining that the packet corresponds to voice over Internet protocol traffic if at least three of the following conditions are satisfied
the header indicates a payload length within a specified range,
the header indicates that two UDP ports are even-numbered,
the header indicates a specified RTP version, and
the header indicates a specified contributing source count.

9. The method of claim 8, comprising determining that the packet corresponds to voice over Internet protocol traffic if all four of the conditions are satisfied.

10. The method of claim 8, wherein the RTP version is 2.

11. The method of claim 8, wherein the contributing source count is 0.

12. The method of claim 8, comprising determining whether a codec value of the packet corresponds to audio or voice.
